(19) United States
(12) Patent Application Publication
(10) Pub. No.: US 2003/0168295 A1
(43) Pub. Date: Sep. 11, 2003

(54) Active vibration isolation system

(76) Inventors: Zhixiu Han, Acton, MA (US); Anil Mavanur, Worcester, MA (US); Chandrashekhar H. Joshi, Bedford, MA (US)

Correspondence Address: Zhixiu Han, Apt. 24, 120 Parker Street, Acton, MA, 01720, US

(21) Appl. No.: 10/365,696

(22) Filed: Feb. 12, 2003

Related U.S. Application Data
(60) Provisional application No. 60/356,215, filed on Feb. 12, 2002.

(51) Int. Cl. F16F 9/53; F16M 11/00

(52) U.S. Cl. 188/267.1; 267/136

(57) ABSTRACT

A vibration isolation system, with an actuator having two nested, relatively movable members defining an interior portion, and a magnetostrictive member coupled to both nested members and within the interior portion. A variable-strength magnetic field is applied to the magnetostrictive member, for controlling the elongation of the magnetostrictive member, to thereby control the relative positions of the two nested members.

### CROSS REFERENCE TO RELATED APPLICATION This application claims priority of Provisional application serial No. 60/356,215, filed on Feb. 12, 2002.

### FIELD OF THE INVENTION

The invention relates to an active vibration isolation system.

### BACKGROUND OF THE INVENTION

Vibration control technology has a wide range of applications. High precision and broad frequency range damping are valuable for semiconductor processing equipment, sensitive instrumentation such as electron or tunneling microscopes, and many other types of instrumentation. The need in industry for vibration isolation is growing. For example, precision motion machines catering to the semiconductor industry give up a large part of their position error budget to vibration errors. Machine tools are subject to external as well as internal vibration sources that seriously limit their manufacturing precision. As the manufacturing of semiconductors and other products becomes more and more precise, the need for suppressing vibrations from any and all sources, even natural environmental vibration, becomes greater and greater.

Vibration isolation systems can broadly be classified as passive vibration isolation systems and active vibration isolation systems. Localized passive vibration isolation is realized by using viscoelastic dampers, such as blocks of rubber or compression springs, for example. The dampers are mounted between the load and the vibration source.

Such passive isolators can reduce the amplitude of vibration for high frequency noise, but actually amplify the vibration for low frequency noise. For example, for rubber, vibration isolation begins at √2 times the resonance frequency, and more isolation is achieved at higher vibration frequencies. However, below that frequency the vibration is actually amplified. To counteract the passive isolator's tendency to amplify low frequency vibrations, large masses are added to the damping system to handle the low frequency vibration, making these systems very large and heavy. However, for most applications, massive passive vibration control systems are undesirable for isolating low frequency vibration due to their size and weight. Some passive isolation systems using pneumatic isolators and negative stiffness technology do have resonance frequencies in the 1 Hz range, but still do not eliminate low frequency vibration (5 Hz and below) because vibration isolation begins at √2 times the resonance frequency, and complete isolation is usually achieved only for frequencies larger than 5 times the natural frequency.

Active vibration isolation technologies overcome some of these difficulties inherent in passive isolation. Active vibration isolation systems typically include a passive vibration isolation portion to isolate the load from high frequency noise, and sensors and actuators for active isolation from low frequency vibration. Thus, active isolation systems can operate reliably over a wide range of frequencies.

U.S. Pat. No. 5,000,415 discloses an isolation system that includes a sensor that senses the movement of the floor, and a control loop to synchronize the contraction/expansion of the actuators with the movement in the floor. The patent also discloses the use of sensors which sense the velocity of the load to provide a feedback loop that is coupled to a feedforward loop. The piezoelectric actuators and control loops are capable of isolating the load for relatively low frequencies. An elastomeric mount that is interposed between the load and the actuators rolls off the high frequencies. The elastomeric mount has a resonant frequency that varies with the weight of the load. This variation in the resonant frequency requires the calibration of the system during installation, or a reconfiguration of the system to compensate for a different load. It would be more desirable to provide an elastomeric mount with a resonant frequency that is relatively constant for a predetermined range of load weights.

U.S. Pat. No. 5,660,255 discloses a vibration isolator with a number of piezoelectric actuators to isolate a load in the vertical direction, and additional piezoelectric actuators to isolate the load in the horizontal direction, which provides active isolation in both the vertical and horizontal directions. However, piezoelectric actuators are relative expensive. Therefore, providing additional horizontal actuators increases the cost of assembling the vibration isolator. It would be desirable to have effective vibration isolators that can provide vertical and horizontal isolation, and which cost less to produce than the disclosed isolators.

U.S. Pat. No. 6,209,841 discloses a vibration isolator for isolating a load from a surface. The vibration isolator may have an active isolator assembly that isolates the load in a first direction, and a passive isolator assembly that isolates the load in a second direction. The active isolator assembly may include a single actuator that is coaxially aligned with a sensor. The sensor and actuator can be connected to a controller that provides active isolation of the load. The actuator is a piezoelectric actuator, and the sensor is a geophone velocity sensor. The passive isolator assembly may include a pendulum that is coupled to a dashpot.

Others have developed active vibration isolators including a three-dimensional isolation table that can provide 10 to 20 dB vibration isolation at 1 Hz. Piezoelectric actuators and geophone velocity sensors are employed in such products.

Such active vibration isolation technologies solve the problem of isolating a load from a fairly wide range of noise frequencies. However, these designs may not be able to properly isolate vibrations at low cryogenic temperatures. Viscoelastic materials work poorly or not at all at low temperatures, depending on the viscosity of the viscoelastic materials, a property that is highly temperature dependent. Also, the performance of piezoelectric actuators degrades dramatically as temperature decreases. Such actuators perform minimally, if at all, at cryogenic temperatures. It would therefore be desirable to provide a vibration isolator which can work effectively at both low and high frequency, and across a broad temperature range, from room temperature to cryogenic temperatures.

### SUMMARY OF THE INVENTION

Advantages of the invention comprise the capability of damping high and low frequency vibrations over the entire temperature range from room temperature down to cryogenic temperatures, compact size with high resolution, and low power requirement.

The present invention comprises an active vibration isolator. The invention is capable of damping vibration from room temperature down to cryogenic temperatures, in a wide range of frequencies. It has nanometer level resolution, and requires little power for operation.

The inventive system includes a passive vibration isolation portion to isolate a load from high frequency noise, and also includes sensors and magnetostrictive smart material (MSM) based actuators for active vibration isolation of low frequency noise. The inventive system is also capable of damping vibration from room temperature down to cryogenic temperatures.

Magnetostrictive Smart Materials

Magnetostrictive smart materials (MSM) exhibit strains as high as 0.63% at cryogenic temperatures. Actuators based on these materials can generate very large forces—a necessity for moving heavy objects or shaping stiff objects.

Magnetostriction is a size change in any dimension of a ferromagnetic material caused by a change in its magnetic state. Magnetostriction arises from a reorientation of the atomic magnetic moments. When the magnetization is completely aligned, saturation occurs and increasing the magnetic field can produce no further magnetostriction. The amount of magnetostriction at saturation is the most fundamental measure of a magnetostrictive material. The modern era of magnetostriction began in 1963 when strains approaching 1% were discovered in the rare earth materials, terbium (Tb) and dysprosium (Dy), at cryogenic temperatures. Since then, many materials have been shown to exhibit magnetostrictive behavior including several materials at room temperature. Also known is the magnetostrictive material disclosed in U.S. Pat. No. 6,451,131. This material can operate throughout the temperature range of 0 K to above 300 K.

Magnetostrictors have significantly higher strain energy than PZT, the most commonly used piezoelectric actuator material. For vibration damping and isolation, magnetostrictive actuators are more efficient. This translates directly into smaller actuator requirements.

The main advantages of the present invention include:

1) Capability to operate over the entire temperature range from room temperature to cryogenic temperatures

2) Capable of achieving extremely precise and highly repeatable motion

3) Compact and self contained unit that is readily retrofitted in most systems

4) Operates over a large frequency range for vibration isolation

5) Can accomplish a six degree of freedom vibration isolator

This invention features a vibration isolation system, comprising an actuator comprising two nested, relatively movable members defining an interior portion, a magnetostrictive member coupled to both nested members and within the interior portion, and means for creating a variable-strength magnetic field that is applied to the magnetostrictive member, for controlling the elongation of the magnetostrictive member, to thereby control the relative positions of the two nested members.

Both nested members may be tubes. The magnetostrictive member may be a rod with one end coupled to one tube, and the other end coupled to the other tube. The means for creating a variable-strength magnetic field may comprise a coil and means for varying the current provided to the coil. The coil may surround the magnetostrictive member rod and be located within the tubes. The vibration isolation system may further include a spring for providing a preload force on the magnetostrictive member.

The vibration isolation system may further comprise means for sensing vibrational motion of the actuator. The means for creating a variable strength magnetic field may be responsive to the means for sensing vibrational motion, for creating forces to counteract the vibrations.

The vibration isolation system may further comprise a passive damper. The vibration isolation system may further comprise a flange coupled to one nested member, for contacting a structure to be isolated from vibration. The vibration isolation system may further comprise one or more permanent magnets proximate the magnetostrictive member, to magnetically bias the magnetostrictive member. There may be a permanent magnet proximate at least one end of the rod, or there may be a permanent magnet fully or partially surrounding the rod along at least a portion of its length.

The invention also features a multi-axis mounting platform comprising at least three pairs of the described actuators, mounted between a base and a movable top, with means for controlling the magnetic field applied to the magnetostrictive member of each actuator, to position the base and top relative to one another. The pairs of actuators may be distributed equally around the periphery of the platform. The actuators in each pair may be mounted at an angle of about 90-110 degrees from one another.

### BRIEF DESCRIPTION OF THE DRAWINGS

FIG. 1 is a schematic, cross-sectional view of an embodiment of a vibration isolator for the invention;

FIG. 2 shows the vibration isolator of FIG. 1, but with a different permanent magnet arrangement;

FIG. 3 is a schematic, cross-sectional view of the preferred embodiment of the vibration isolator for this invention;

FIG. 4 is a block diagram of the preferred control scheme for the invention;

FIG. 5 depicts the idealized response of the control scheme of FIG. 4;

FIG. 6 is a simplified view of an embodiment of the invention comprising a multiaxis mounting structure based on a Stewart platform; and

FIG. 7 is a block diagram of the preferred control scheme for the embodiment of FIG. 6.

### DETAIL DESCRIPTION OF THE PREFERRED EMBODIMENTS OF THE INVENTIONS

Design Concepts

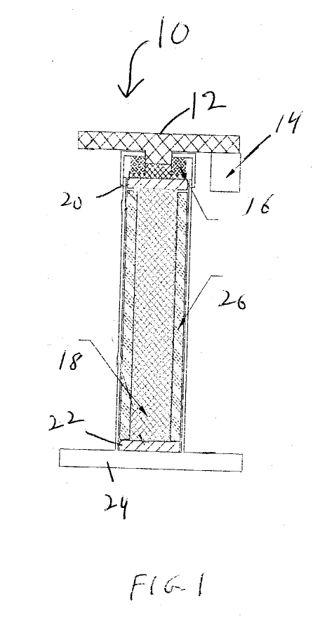

FIG. 1 shows a full design concept of the invention. The magnetostrictive smart material (MSM) rod 18 is biased by permanent magnet discs 20 and 22 located proximate each end of rod 18. A bi-polar controlled coil 26 intensifies or reduces the magnetic field of the permanent magnet, thereby lengthening or shortening the MSM rod, respectively. The realized motion of the actuator takes place on the top flange 12. Isolation material 16 is in contact with this flange to reduce the effects of high frequency disturbances. A velocity or acceleration sensor 14 is placed on the top flange as part of the control loop.

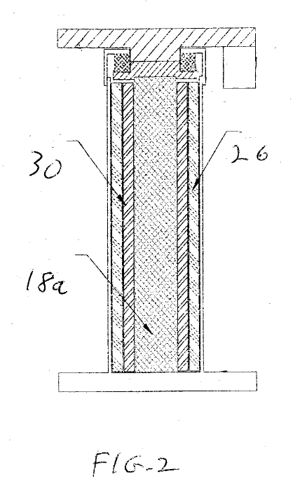

FIG. 2 shows another design for the invention. This concept differs from that of FIG. 1 in that the permanent magnet 30 is fully or partially annular and is placed around some or all of the length of the MSM rod 18a, as opposed to disks on either end. Coil 26 can be located outside of magnet 30 as shown, or inside of the magnet.

Engineering Design

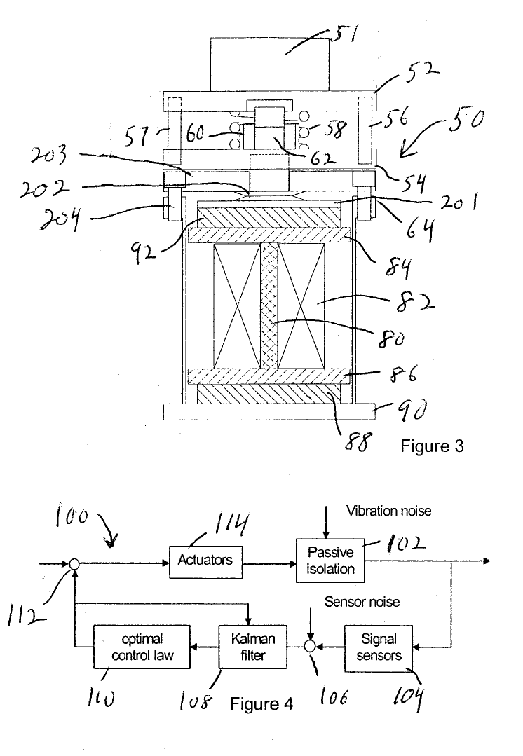

The design concepts of FIGS. 1 and 2 are the basis for the product design described in FIG. 3. The design of FIG. 3 has two parts: part one, which is the top part, is the passive vibration isolator, and below it is the actuator for active vibration control.

For the passive vibration isolator portion, a compression spring and Coulomb damping designs are used, so that the device can operate at cryogenic temperatures. The sensor 62, which is compatible at cryogenic temperatures, is located inside the blind hole in the top flange 52, and is used to implement active vibration control. The intermediate flange 54 has a protruding tube 60 whose outside diameter is in contact with the coils of spring 58. When the payload 51 vibrates, Coulomb damping occurs when the coils of spring 58 slide on the outer diameter of tube 60. The bottom part of spring 58 is in contact with the tube, which provides the Coulomb damping; the top part of spring 58 is free from any surface contact, which provides the high frequency vibration isolation.

For the actuator portion, permanent magnets 88 and 92 generate a magnetic field along the MSM rod 80, and bias the MSM rod displacement. An optimal control loop is employed to control a bi-polar magnet coil 82, to intensify or reduce the magnetic field of the permanent magnet, thereby lengthening or shortening the overall length of the MSM rod, respectively. The high-resolution contraction or expansion of the MSM provides the actuator the capability to control the vibration of the top flange at nanometer level. Two pieces of iron, 84, 86, provide return paths to make the magnetic field along the MSM rod more uniform. The preload screw 201 faces down on the permanent magnet 92, and its screw goes through washers 202, the second intermediate flange 203, and is firmly connected to the first intermediate flange 54. Screw 204 is used to connect the second intermediate flange 203 and the actuator house 64 together, and provides preload on MSM 80.

Control Loop Design

Control of an active vibration system is determined by its control loop design. The preferred control algorithm for the invention 100, FIG. 4, is based on the Kalman filter and LQR optimal control theories. Any vibration noise on a payload is transferred to the passive isolation part 102. Signal sensors 104 can sense the vibration noise from the payload and pass it to the controller. A Kalman filter 108 is used to generate optimal estimates of the system states. The Kalman filter minimizes the mean square error between the calculated system state and the measured system state to produce optimal estimates. The regulator algorithm 110 takes its inputs from the Kalman filter and calculates the displacement of the actuator necessary to counter the vibration input sensed from the sensor. These signals are again run though the Kalman filter to smooth out noise. This produces a current proportional to signals from the regulator. This current magnetizes the rod to produce the required amount of magnetostriction. The rod magnetostriction is the output of the actuator 114. The output displacement working on the passive isolation 102 can stabilize the payload.

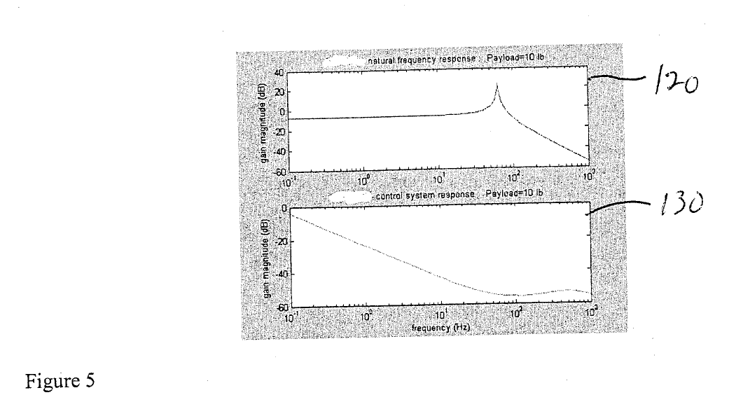

FIG. 5 shows the control system simulation results for vibration isolation. The simulation results show that the disclosed control system can reduce the vibration 120 on the payload from −5 dB to −50 dB in a frequency range from 0.1 Hz to 100 Hz; curve 130.

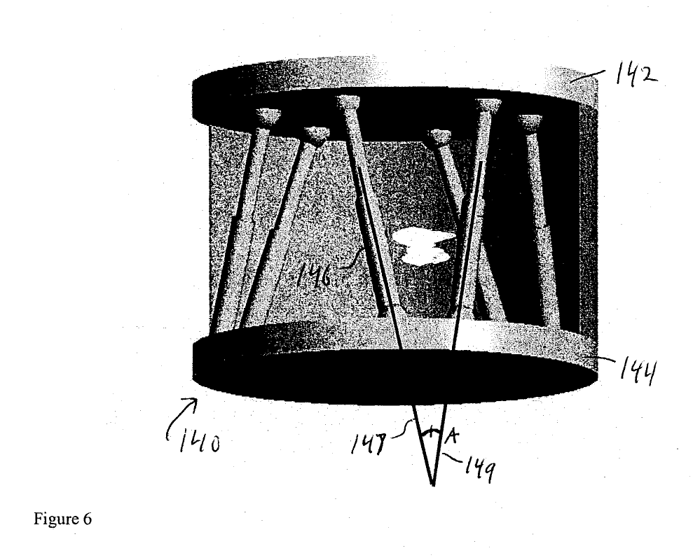

FIG. 6 shows an embodiment of the invention comprising a multi-axis mounting structure 140 based on a Stewart platform. This type of platform uses a set of six struts of the type described above. The struts are magnetostrictive-based actuators and are capable of precise motion in one dimension. These actuators are mounted in pairs (pair 146 and 148 lying along longitudinal axes 146 and 148, respectively) between the base 144 and a movable platform 142. This structure has the ability to provide a highly stable but movable support for large masses. Actuator pairs are mounted at an angle A of 90-110 degrees from each other, and the three pairs are distributed equally around the periphery of the platform. By energizing these six actuators in the correct manner and in the correct sequence, six degrees of motion can be obtained including x-, y-, z-translation as well as yaw, pitch and roll.

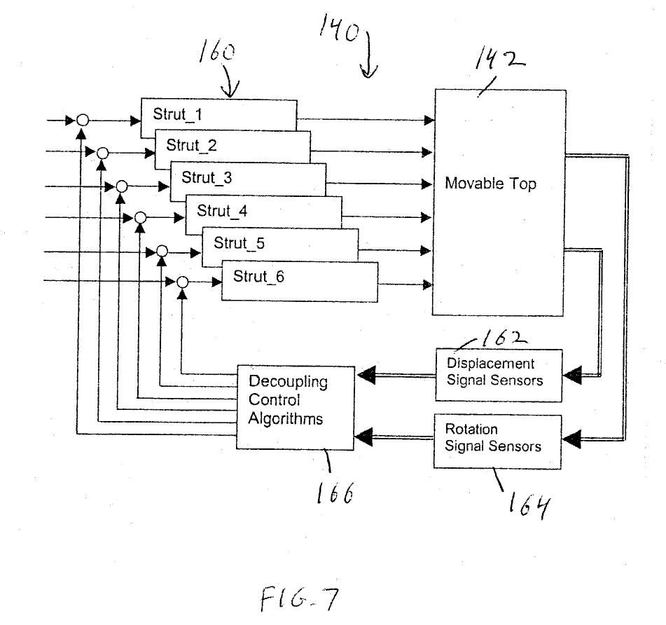

The basic idea of the control strategy for the FIG. 6 embodiment, 140, is shown in FIG. 7, which is a modification of the feedback method for vibration control. A bank of six sensors is used to detect motion in the 6 degree of freedom (3 translational 162 and 3 rotational 164). Decoupling algorithms 166 are used to translate the absolute position and orientation of the movable top 142 in terms of linear distances through which each of the actuators need to move. The output of this algorithm is used to drive the actuators 160 in order to counter the motion detected by the sensors.

Although specific features of the invention are shown in some drawings and not others, this is for convenience only as some feature may be combined with any or all of the other features in accordance with the invention.

Other embodiments will occur to those skilled in the art and are within the following claims:

What is claimed is:

1. A vibration isolation system, comprising:
an actuator comprising two nested, relatively movable members defining an interior portion;
a magnetostrictive member coupled to both nested members and within the interior portion; and
means for creating a variable-strength magnetic field that is applied to the magnetostrictive member, for controlling the elongation of the magnetostrictive member, to thereby control the relative positions of the two nested members.

2. The vibration isolation system of claim 1, wherein both nested members are tubes.

3. The vibration isolation system of claim 2, wherein the magnetostrictive member is a rod with one end coupled to one tube, and the other end coupled to the other tube.

4. The vibration isolation system of claim 3, wherein the means for creating a variable-strength magnetic field comprises a coil and means for varying the current provided to the coil.

5. The vibration isolation system of claim 4, wherein the coil surrounds the magnetostrictive member rod and is within the tubes.

6. The vibration isolation system of claim 1, further comprising a mechanical structure for providing a preload force on the magnetostrictive member.

7. The vibration isolation system of claim 1, further comprising means for sensing vibrational motion of the actuator.

8. The vibration isolation system of claim 7, wherein the means for creating a variable strength magnetic field is responsive to the means for sensing vibrational motion, for creating forces to counteract the vibrations.

9. A multi-axis mounting platform comprising at least three pairs of the actuators of claim 1, mounted between a base and a movable top, with means for controlling the magnetic field applied to the magnetostrictive member of each actuator, to position the base and top relative to one another.

10. The vibration isolation system of claim 9, wherein the pairs of actuators are distributed equally around the periphery of the platform.

11. The vibration isolation system of claim 10, wherein the actuators in each pair are mounted at an angle of about 90-110 degrees from one another.

12. The vibration isolation system of claim 1, further comprising a passive damper.

13. The vibration isolation system of claim 1, further comprising a flange coupled to one nested member, for contacting a structure to be isolated from vibration.

14. The vibration isolation system of claim 3, further comprising one or more permanent magnets proximate the magnetostrictive member, to magnetically bias the magnetostrictive member.

15. The vibration isolation system of claim 14 in which there is a permanent magnet proximate at least one end of the rod.

16. The vibration isolation system of claim 14 in which a permanent magnet fully or partially surrounds the rod along at least a portion of its length.

17. A vibration isolation system, comprising:
an actuator comprising two nested, relatively movable tubes defining an interior portion;
a magnetostrictive rod with one end coupled to one tube, and the other end couples to the other tube, the rod located within the interior portion;
means for sensing vibrational motion of the actuator; and
a coil surrounding the rod, and means, responsive to the means for sensing vibrational motion, for varying the current provided to the coil, for creating a variable-strength magnetic field that is applied to the magnetostrictive member, for controlling the elongation of the magnetostrictive member, to thereby control the relative positions of the two nested tubes and counteract the sensed vibrations.
